(19) United States
(12) Patent Application Publication
(10) Pub. No.: US 2004/0152046 A1
(43) Pub. Date: Aug. 5, 2004

(54) Orthodontic and/or orosurgical device

(76) Inventors: Roger Minoretti, Zurich (CH); Albino Triaca, Zurich (CH); Beat Merz, Zurich (CH)

Correspondence Address: Karl F Milde Jr, Milde & Hoffberg, Suite 460, 10 Bank Street, White Plains, NY, 10606, US

(21) Appl. No.: 10/477,090

(22) PCT Filed: May 10, 2002
(86) PCT No.: PCT/EP02/05146

(30) Foreign Application Priority Data
May 10, 2001 (CH) 2001 0845/01

(51) Int. Cl. A61C 8/00; A61C 3/00

(52) U.S. Cl. 433/173; 433/18

(57) ABSTRACT

The present invention relates to a device for orthodontic and/or orosurgical purposes, the device comprising an elongated, dimensionally stable, self-supporting profiled element, some sections of which are curved and approximate to the vestibular side of a dental arch, the profiled element being held by at least one front fixing element that can be anchored in the bone and is allocatable as a rule to the interforaminal region of the submaxilla or to the anterior mandible, and the profiled element forming at least one anchorage point, upon which a retaining member is acting, for a segmental distraction or a bone-supported orthodontic tooth displacement.

The present invention relates to a device for orthodontic and/or orosurgical purposes. Such devices are used in the field of orthodontics and orosurgery.

In the orthodontic treatment of malpositions of teeth, the latter are moved and/or tilted by means of relatively small forces in the order of a few Newtons in the alveolar ridge. This treatment may sometimes last for years because teeth can only moved at a slow pace.

Normally, the forces are generated by springs clamped between the teeth, for instance, in order to pull neighboring teeth into a gap. This is also called parodontal anchorage because the teeth used for anchoring are also moving, and it is not possible without an additional anchorage appliance, e.g. in the form of an extraoral apparatus, to move only the teeth at the one end of the springs and to keep the others stationary.

In many cases, however, it is not desired that anchorage teeth are moving, for instance because of the reason that one wishes to close a gap only with the distally projecting teeth. In other cases, e.g. when there is no contact of the teeth or in the case of parodontal damage, it is almost impossible to find teeth suited for anchorage. This will only leave measures taken with the help of extraoral anchorage appliances, so-called headgears, or anchorage via an apparatus to be fixedly screwed onto the jawbone or neighboring bones.

The said headgears are, on the one hand, not suited for all kinds of treatments. On the other hand, cooperation on the patient's part is most of the time very poor in the case of such non-esthetic and objectionable devices on the head, so that the treatment result is at risk. Bone-supported anchorage has the advantage that it cannot move under the small orthodontic forces and can thus serve as an absolute anchorage point.

Such bone-supported anchorage is known from various documents. For instance, European Patent No. EP 95934033.2-2309 describes a special implant that is fixed in the palate suture and serves there the bone support of anchorage teeth in the upper jawbone.

Moreover, U.S. Pat. No. 5,921,747 describes other special anchorage screws or pins that are inserted between the roots of the teeth and may serve as anchorage for teeth or orthodontic apparatus.

All of these types of anchorage have the drawback in common that they only offer a pointwise support which for anatomical reasons is most of the time not positioned exactly at the place where the stabilization proper is needed or where the spring force vector should point to. That is why such anchorage must often be combined with expensive apparatus to create the desired anchorage or force action (see the publication Mannchen R.: “A New Supraconstruction For Palatal Orthodontic Implants”, J. Clin. Orthod. 1999; 33: 373-382).

While in the supermaxilla the hard palate or the central suture thereof is available for use, only the alveolar ridge can normally be used in the submaxilla with the existing anchoring possibilities. On account of the existing teeth, the screw- or pin-like anchorage must be mounted between the roots of the teeth, which may be difficult and dangerous for the roots on the one hand and may often entail problems with the soft tissue on the other hand.

It is therefore an object of the present invention to provide a device for orthodontic and/or orosurgical purposes that avoids the above drawbacks and particularly offers an optimally adjustable support for the respective orthodontic or orosurgical operation.

In the orosurgical treatment with distraction of bone segments, such bone segments are separated from the remaining bone, and the developing healing callus is then distracted in order to gain new bone mass.

A typical example is the so-called pre-prosthetic distraction of the alveolar ridge with the aim to reconstruct alveolar ridge height that has been lost because of toothlessness and corresponding resorption in order to be able to insert dental implants. Devices for such uses are e.g. presented in the International Patent Publication No. WO98/16163 or German Patent No. DE 19804316 A1.

These constructions have the drawback in common that they either allow for a relatively low control of the distraction direction (e.g. WO98/16163), that for constructional reasons they must most of the time be located directly at the distraction site, or they are relatively inflexible with respect to the exact definition of the distraction direction. The exact observance of a predetermined distraction direction, however, is very important because it is only through such an exact observance that bones are effectively created at the place where a bone is needed, for instance, for anchoring a dental implant.

The above objective is achieved by means of a device for orthodontic and/or orosurgical purposes, the device comprising an elongated, dimensionally stable, self-supporting profiled element, some sections of which are curved and approximate to the vestibular side of a dental arch, the profiled element being held by at least one front fixing element that can be anchored in the bone and is allocatable as a rule to the interforaminal region of the submaxilla or to the anterior mandible, and the profiled element forming at least one anchorage point, upon which a retaining member is acting, for a segmental distraction or a bone-supported orthodontic tooth displacement.

This device, which is used in the fields of orthodontics and orosurgery, gives the operator the possibility of creating a stable and bone-supported anchorage, e.g. in order to displace and/or tilt teeth with orthodontic means in the alveolar ridge or, however, to distract separated segments of jawbones in a controlled and targeted manner. The device is based on the principle to create a fixation remote from the roots of the teeth and to be able to align the arrangement in any desired position along the alveolar ridge or arch, with a plurality of independent springs being adapted to be aligned and fixed on the profiled element via corresponding retaining members so as to move e.g. individual teeth in a targeted manner and at the same time. Thanks to this specific construction, it is also possible to easily satisfy the orthodontist's needs, which are changing with a progressing treatment. A special advantage is also that the device can be positioned with the profiled element above the occlusion plane to be able to exert a tensile force on the corresponding tooth and bone regions during treatment.

The device according to the present invention can be fixed, on the one hand, away from the place of distraction at a surgically optimum place and permits, on the other hand, a flexible, but stable, fixation of the distraction direction by virtue of its construction. Furthermore, a large-area and easily controllable distraction is also made possible when e.g. a large part of the alveolar ridge is to be distracted vertically at the same time.

While the device in its basic structure comprises a fixing element on which the profiled element is retained, with individual retaining members, in turn, being adapted to be positioned as fixing points on said profiled element, it is of advantage to extensive orthodontic or orosurgical treatments to retain the correspondingly long profiled element with a second fixing element such that the profiled element is clamped between two of said fixing elements. One of said fixing elements is anchored in the region of the ramus ascendens or the posterior corpus mandibulae.

Thanks to its relatively simple construction and the resulting small constructional size, the fixing element can be anchored either to the bone or to the tooth.

As has already been mentioned, the profiled element which is retained either on a fixing element in the form of a projecting arm or is arranged between two fixing elements in the form of a cross member offers the possibility of providing anchoring points at any desired place in that a corresponding number of retaining members are mounted on the profiled element.

For a large range of possible variations the retaining members can preferably be displaced on the profiled element and fixed by locking means in their position, the retaining members being designed for orthodontic and/or orosurgical measures and forming the anchorage points on the profiled element.

The profiled element can be designed to span the whole dental arch, each of the two ends having a fixing element that can be assigned to the ramus ascendens dexter or the posterior corpus mandibulae dexter and to the ramus ascendens sinister or the posterior corpus mandibulae. In this arrangement, too, the respective fixing element can be anchored on the bone or on the tooth.

For instance, in order to approximate to the curvature of the dental arch, it may be of advantage that the profiled element is composed of link elements that are screwed to one another and can be adjusted in their relative position to each other.

A further possibility of adjustment that is especially of importance in the case of orthodontic and orosurgical operations is provided whenever the profiled element is arranged on the rear fixing element by means of an articulation. Such an articulation may be a ball element that can be anchored in the bone and is gripped around by a clamping member that can be assigned to the profiled element. Another possibility of constructing said articulation is achieved with a plug-type connection.

To be able to adjust said articulation in its angular orientation in any desired way, i.e. in all directions, the fixing element may assume the form of a screw with a ball head.

A preferred arrangement is obtained whenever the rear fixing element is provided with at least two brackets that extend at the exterior and interior side of the ramus ascendens and have holes for one or several bone screws at least at the one side.

In a further construction the fixing element may also comprise a clip that can be activated by a screw and has ends gripping around the rear and front edge of the ramus ascendens. This yields some kind of clip. Said clip, which may be U-shaped, may then be provided in the middle of the curvature with an inwardly bent mandrel which is configured to engage into and anchor itself in the bone upon tightening of the screw.

A so-called strap can be used for the connection between fixing element and profiled element.

For orosurgical measures the respective retaining member may have an end in the form of a U-shaped clip, when viewed in cross-section, with free ends facing one another.

Furthermore, the respective retaining member for orosurgical measures may comprise an end in the form of a pin.

Moreover, the fixing element may extend in bulging fashion towards the lingual side for orosurgical purposes.

When the profiled element is equipped with a circular cross-section, the corresponding retaining members that are mounted on said profiled element can be rotated into the desired radial or angular position to meet the respective requirements.

If a stable position of the retaining member is needed on the profiled element, the profiled element should have a non-circular cross-section for receiving a moment around its longitudinal axis. A preferred cross-sectional shape is here quadrangular or rectangular.

Anchoring points that form snap-type locations may be provided on the profiled element as additional retaining measures of the retaining member. Such anchoring points may be formed by grooves or recesses.

The fixing element may also comprise a rod-like section along which the profiled element is held in a displaceable and fixable manner. This permits a vertical orientation and alignment.

The specific advantages that follow from the above-described constructional measures are evident to one skilled in the art.

Further advantages and features of the invention become apparent from the following description of embodiments with reference to the drawing, in which:

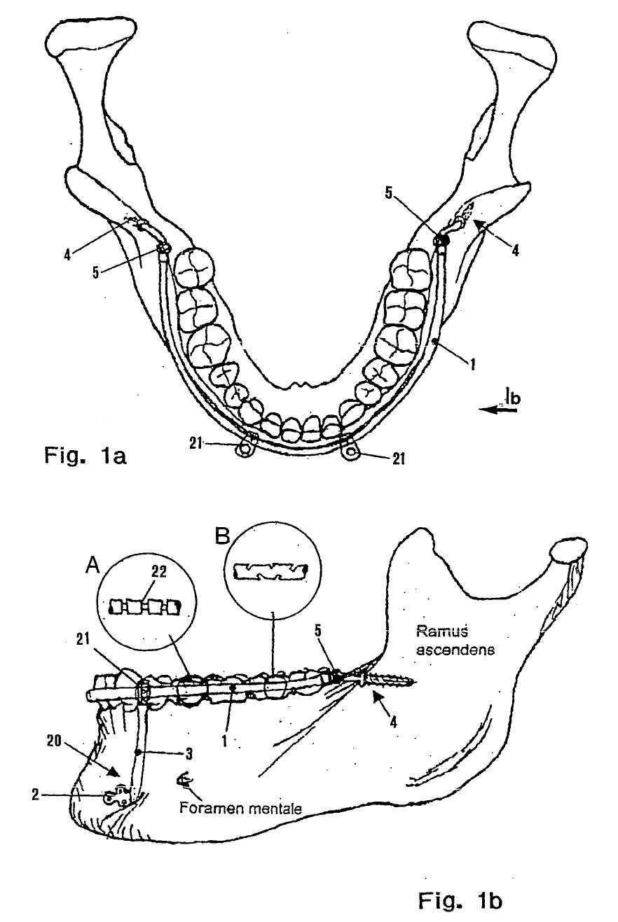

FIG. 1a is a top view on the submaxilla with a profiled element completely following the toothing, wherein the connection to the rear screw-like bone attachments is established via a ball-and-socket joint while the front support is formed through two interforaminally installed bone plates with vertical connection cylinders;

FIG. 1b is a side view of the illustration of FIG. 1a from the viewing direction of arrow 1b in FIG. 1;

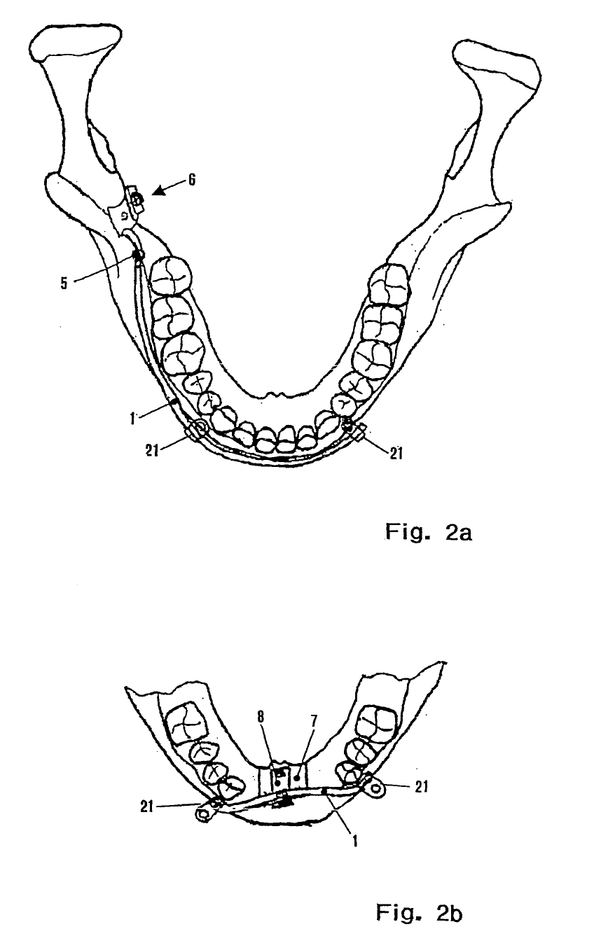

FIG. 2a shows an illustration according to FIG. 1a, where the retaining member does not follow the whole alveolar ridge; the rear fixation has the shape of a bone plate adapted to the topography and including a connection member projecting out of the mucous membrane or with a fixing element with a ball head;

FIG. 2b is a further illustration according to FIG. 1a; in this instance, however, the profiled element is only supported on the two interforaminally fixed bone plates with vertical connections; in this variant, the profiled element serves the augmenting distraction of an interforaminal segment of the alveolar ridge;

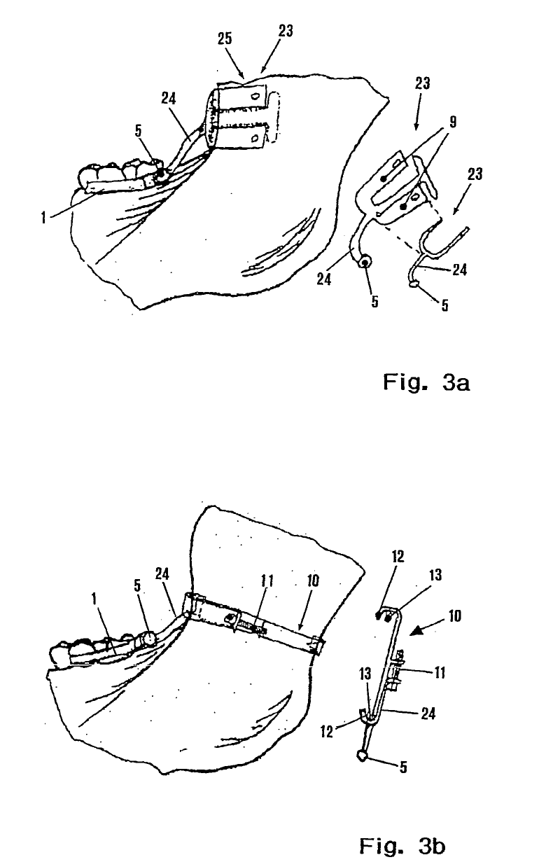

FIG. 3a shows a variant of the rear fixing element, where the two plate members are fixed externally to the ramus ascendens by screws, while an interior bracket imparts additional stability;

FIG. 3b is a further illustration, similar to that of FIG. 3, of the rear fixing element, wherein a kind of clip is clamped with a screw to the ramus ascendens without the need for drilling screws thereinto;

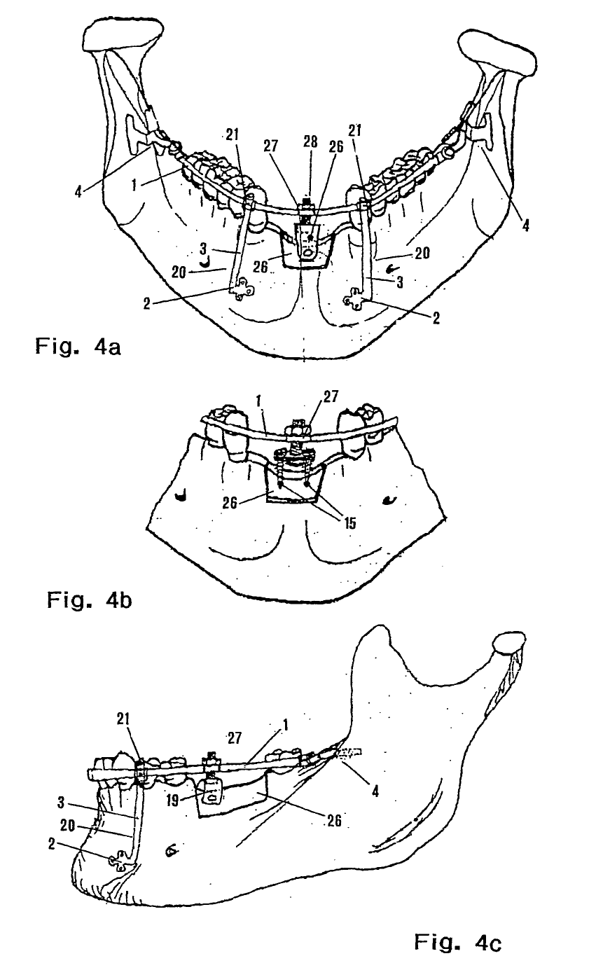

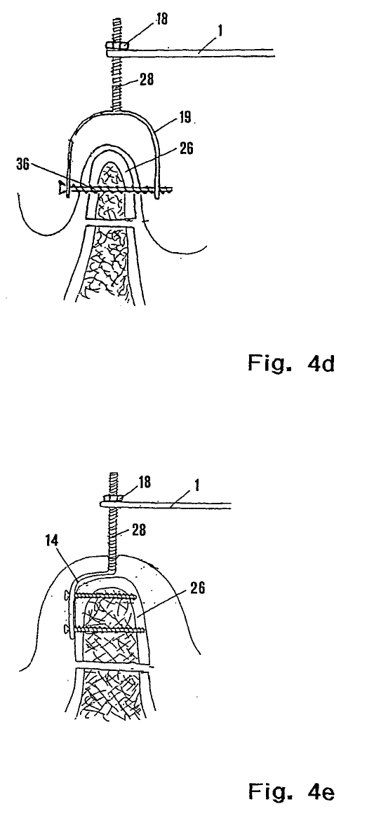

FIG. 4a is a view from the front of the submaxilla, wherein a device is provided with a completely surrounding profiled element; with this profiled element, an anterior segment of the alveolar ridge is first distracted vertically, and further orthodontic corrections can then be made with a support on the profiled element; the anterior segment is fixed via a member resembling a stirrup;

FIG. 4b shows a situation comparable with FIG. 4a, where the segment to be distracted is retained with screws on the vertical distractor;

FIG. 4c shows a situation analogous to FIG. 4a, where a segment is vertically distracted in the lateral alveolar ridge;

FIG. 4d shows an arrangement with a fixing element in the form of a U;

FIG. 4e shows an arrangement comparable to that of FIG. 4d, with a fixing element directly resting on the bone;

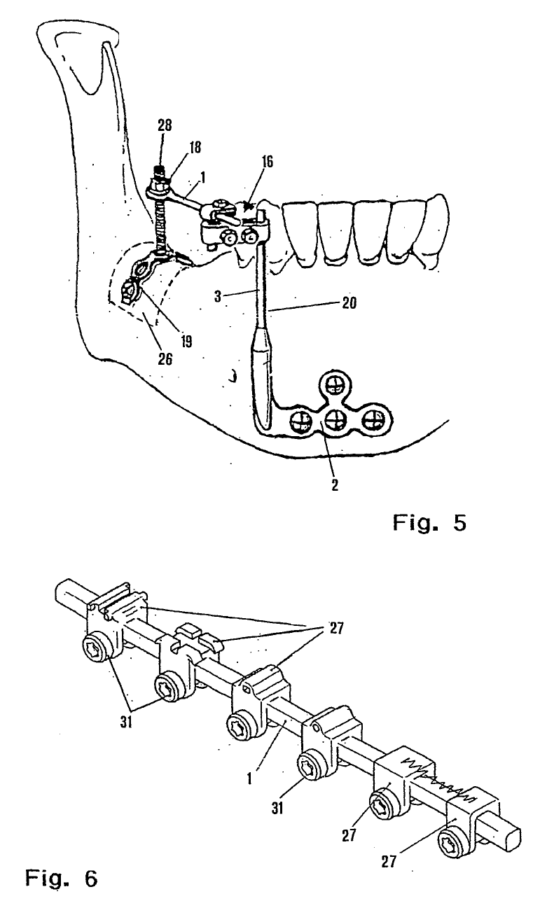

FIG. 5 shows the device in the variant of a crane-like distractor; with this distractor, the profiled element is exactly aligned above the distraction zone with an accurately set distraction vector;

FIG. 6 shows a profiled element with a plurality of differently designed retaining members mounted thereon;

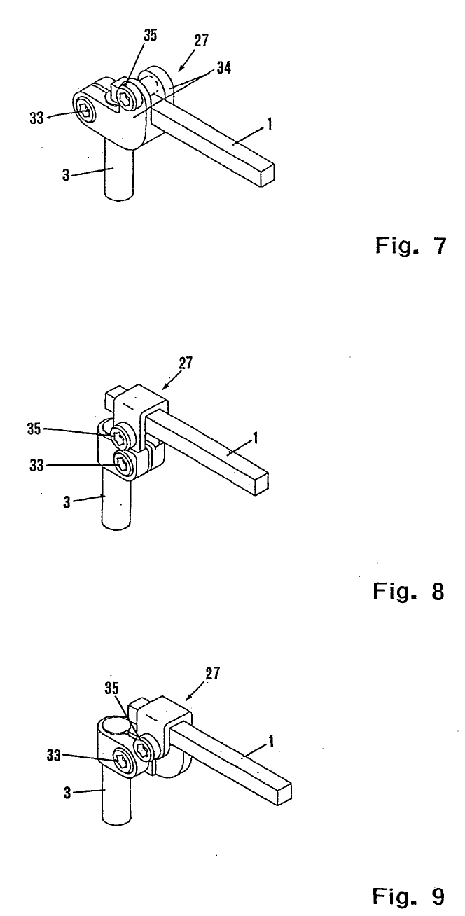

FIG. 7 shows the connection between a connector and a profiled element in a first variant;

FIG. 8 shows the connection between a connector and a profiled element in a second variant; and

FIG. 9 shows the connection between a connector and a profiled element in a third variant.

In the following description, the profiled element will also be referred to as a rail, especially when the device is used for segmental distraction and bone-supported orthodontics, when it rests on at least two supports and has a corresponding shape extending along the dental rim. In the following description, the device will also be designated as a crane distractor when the profiled element has only one bone support and is provided with joints, if necessary.

FIGS. 1a and 1b show the device in variant 1 as a rail from the top and from the side, respectively. The rail consists of a profiled element 1 which in this drawing is guided around the dental arch and which at the front in this instance is carried by two special bone plates 2 placed interforaminally (i.e. in front of the nerve exit or foramen mentale) and including vertical connectors 3. The respective bone plate 2 and the respective connector 3 form a fixing element 20 for the profiled element 1. The vertical connectors 3 may assume the form of a cylinder, whereby a clamp strap 21 can be placed at the upper end, which retains the rail 1, in any position along and around the cylinder. The vertical connector 3, however, may also assume a rectangular or other cross-section, whereby it may become easier to solder or weld e.g. an orthodontic bracket directly thereto.

The profiled element 1 may have either a circular cross-section so as to fix again a clamp connection to be fixed thereto in any desired position or location, or it may have a non-circular cross-section for intercepting a torque around the longitudinal axis. In both cases the profiled element 1 may also be provided with recesses 22 to directly fix e.g. orthodontic wires or brackets thereto. The recesses 22 may have the shape of surrounding grooves (detail A), of asymmetrically milled grooves (detail B), or of areas on which a bracket can be arranged. A displacement and positioning of a clamp connection or a retaining member on the rail 1 is not impaired by said recesses.

If the rail or profiled element 1 extends up to the rear molars, it can be held there via an element fixed e.g. in the ramus ascendens. The arrangement as shown is e.g. a special bone screw 4 with a ball head 5 which in turn is enclosed by a pan, which is mounted at the end of the rail 1 and offers a screw-activated clamping possibility, and thus allows for a stable position that can easily be adjusted during surgery.

As can especially be seen in FIG. 1, the height of the profiled element 1 can be set via the two fixing elements 20 with the connectors 3 and the clamp strap 21 in such a way that the profiled element or rail 1 is positioned at a specific height laterally from the row of teeth, as shown in FIG. 1b, or is positioned in the area of the occlusion plane or above said plane to take corresponding orosurgical and orthodontic measures.

In contrast to the arrangement of FIG. 1a, FIG. 2a shows the rail or profiled element 1 not drawn around the whole dental rim because a treatment is e.g. not needed in the left rear part of the denture. In this example, the rear support assumes the shape of a bone plate 6 which is fixed with standard bone screws (not shown in more detail) and is equipped at the front with an extension, again with a ball head 5, as a connection to the rail 1. As has been described above, said ball head 5 is surrounded by a pan assigned to the rail 1.

FIG. 2b shows a very short variant of rail 1. In this instance, the rail serves to vertically distract a bone segment 7 sawn out of the alveolar ridge. The bone segment 7 is fixed with standard bone screws (not shown in more detail) to a bone plate 8. Said bone plate 8 is connected via an adjustable vertical connection to the rail 1 which in the sense of a distraction permits a gradual and controlled upward movement (see also FIG. 5 described hereinafter). Typically, this can be carried out via a threaded rod with an adjusting nut, but also via a flexible wire pull.

FIGS. 3a and 3b show further specific designs of a rear fixing element 23. The connection to the rail or the profiled element 1 is again established via a fixable ball head 5 on a short arm 23, the special bone plate 25 in FIG. 3a assuming the shape of a “U” when viewed from the top, as can clearly be seen in the two left detail illustrations. At the one side two brackets 9 with holes for standard bone screws are mounted while the other side has just a supporting function but could definitely include holes for a fixation.

FIG. 3b shows the fixation via a contractible clamp 10 with an associated arm 25 carrying the ball head 5. The clamp 10 is contracted via a screw 11. It is provided at both ends with an arc 12 including a mandrel 13 in the area of the inner curvature, the mandrel digging into the bone. Instead of the ball heads 5 on the rear fixation, as shown in FIGS. 2a, 3a and 3b, the rear fixing unit 10 could also carry a clamping device at the front end of the connection arm for tightly clamping the rail 1 or a coupling element assigned to it, or a plug-type device.

FIGS. 4a to 4c show applications of the rail or the profiled element 1, which in the illustrated state serve the vertical distraction of an anterior bone segment 26, e.g., to gain enough bone height for implanting an implant. A retaining member 27 which carries an adjusting mechanism for displacing the bone segment gradually in vertical direction is tightly clamped onto the rail or profiled element 1. A detailed embodiment with such a mechanism is shown in FIGS. 4d, 4e, and 5.

As can be seen in FIGS. 4a, 4b, 4c, and particularly also in FIGS. 4d, 4e and 5, the fixing operation to the bone segment is carried out via a linear bone plate 14 which is connected to the vertical adjusting mechanism and which, depending on the respective application, is bent according to the shape, for instance, of the alveolar ridge, into a U-shaped or stirrup-like form, as is particularly clearly illustrated in FIG. 4d. Said adjusting mechanism comprises a threaded rod 28 which is retained on the profiled element with a nut 18. The threaded rod is pulled upwards by tightening the nut 18 so as to perform the desired distraction. As can be seen in the embodiment of FIG. 4d, the bone segment 26 is retained by means of a screw 36 which is passed through the two ends of the legs of the stirrup and anchored in the bone. As can also be seen with reference to FIG. 4d, the mounting is positioned in the form of the stirrup 19 outside the gingiva or mucosa.

In contrast to the embodiment of FIG. 4d, FIG. 4e shows an embodiment in which the threaded rod 28 has connected thereto a bone plate 14 which directly rests on the bone segment 26, i.e., is adapted to a shape. Said bone plate 14 is screwed with two screws in the bone. Hence, said bone plate is positioned below the gingiva (is subgingival) or below the mucosa (is submucous).

In FIG. 4b, the fixing operation is carried out not via the stirrup-like plate, but by bone screws 15 which are directly integrated into the adjusting mechanism and pierce into the bone segment 26.

Apart from the already discussed mechanism with the threaded rod 28, FIG. 5 shows an application where the device assumes the shape of a crane and a rear support is omitted. The profiled element 1 is extended by interscrewed link elements which are adjustable in their relative position to one another and designated by reference numeral 16. It is possible with these link elements, also called strap chain 16, to position the vertical adjustment unit exactly above the bone segment 26 to be distracted and to lift it in an exactly definable vector. In the present example, the vertical adjusting unit is again equipped with the already discussed mechanism including threaded rod 28 and associated adjusting nut 18. The bone segment 25 is fixed via a plate 19 in bow form bent around the ridge. The plate is located extramucosally, i.e. outside the gingiva.

Since it can be adapted, this construction makes it possible to distract bone segments precisely and in an accurately guided vertical direction and, at the same time, to perform an interforaminal fixation, i.e. before the nerve exit, so that the nervus mentalis is not jeopardized by the bone screws of the anchorage plate.

In addition to the clamp connections shown in FIGS. 1 to 5, it is possible to install joints in addition. These may be capable of bending the vertical distractor out of the vertical, thereby permitting a slightly askew distraction vector.

Clamp connections are shown in FIGS. 7, 8, and 9, while FIG. 6 illustrates a profiled element 1 with individual retaining members 27. The retaining members 27 comprise a substantially U-shaped basic element 29 through the two free legs 30 of which a clamp screw 31 is passed. It is possible with this clamp screw 31 to clamp the two free legs 30 against one another to clamp the retaining member 27 onto the profiled element 1, which has a square configuration when viewed in cross-section. At any time, said retaining members 27 can be displaced and re-orientated by loosening the clamp screw 31. The individual retaining members 27 have different shapes for anchoring the anchorage members. Through-holes, slits and grooves are here cited as a few examples.

In FIG. 6, the two straps mounted furthest to the right on the profiled element are interconnected via a spring to show a possible variant in which the one clamp strap (in the present case the right one of the two straps that are connected with springs) is clamped onto the profiled element 1, whereas the strap positioned at the left side therefrom and connected with the spring element is arranged in sliding fashion. With such an arrangement, the freely slidable clamp at the left side is acted upon with the spring force to apply a corresponding pulling force or, optionally, also pressure to said strap for the specific case of treatment.

FIG. 7 shows a connector 3 and a profiled element 1 with a rectangular cross-section, said members being held by an L-shaped strap 32 at a right angle. The one leg of the strap 32 is slotted to fixedly clamp it via an adjusting screw 33 to the connector 3 while the other leg comprises two brackets 34 between which the profiled element 1 is inserted and which can be clamped against one another by means of an adjusting screw 35. The profiled element 1 can be displaced between the brackets 34 to a desired position and location after the adjusting screw has been unscrewed.

FIG. 8 shows an embodiment of the retaining member 27 which, in turn, shows an L-shaped basic shape in a side view to receive the connector 3 with the one leg and the profiled element 1 with the other leg, said two members being each fixable with the adjusting screws 33 and 35. The adjusting screws are superposed in this embodiment, whereby the constructional size of said retaining member 27 can be reduced.

Finally, FIG. 9 shows a retaining member 27 with a basic shape that is L-shaped in a side view, wherein however the two legs can be pivoted via the one adjusting screw 33, which also fixedly clamps the retaining member 27 to the connector 3, in order to adjust the angular position of the two legs of the retaining member 27 and thus the angular position of the connector 3 and the profiled element 1 relative to one another. It is also evident that the retaining member 27 can be pivoted by loosening the corresponding adjusting screw 3 around the axis of the connector 3, so that an alignment of the profiled element is made possible also in this radial direction around the connector 3.

1. A device for orthodontic and/or orosurgical purposes, comprising an elongated, dimensionally stable, self-supporting profiled element (1), some sections of which are curved and approximate to the vestibular side of a dental arch, said profiled element (1) being held by at least one front fixing element (20) that can be anchored in the bone and is allocatable as a rule to the interforaminal region of the submaxilla or to the anterior mandible, and said profiled element forming at least one anchorage point, upon which a retaining member (21; 29) is acting, for a segmental distraction or a bone-supported orthodontic tooth displacement.

2. The device according to claim 1, characterized in that there is provided a further fixing element (4) that can be anchored in the region of the ramus ascendens or of the posterior corpus mandibulae.

3. The device according to claim 2, characterized in that said fixing element (4) is anchored to the bone.

4. The device according to claim 2, characterized in that said fixing element is anchored to the tooth.

5. The device according to claim 1, characterized in that a plurality of individual anchorage points are formed on said profiled element by a plurality of retaining members (21; 29) that can be arranged thereon.

6. The device according to claim 5, characterized in that said retaining members are displaceable on said profiled element (1).

7. The device according to claim 6, characterized in that said respective retaining member (21; 29) can be fixed by locking means (31) in its position, said retaining members (21; 29) being designed for orthodontic and/or orosurgical measures and forming said anchorage points on said profiled element (1).

8. The device according to claim 1, characterized in that said profiled element (1) is designed to span a whole dental arch, and that each of the two ends comprises a fixing element that can be allocated to the ramus ascendens dexter or to the posterior corpus mandibulae dexter and to the ramus ascendens sinister or to the posterior corpus mandibulae sinister.

9. The device according to claim 8, characterized in that the respective fixing element (20) is anchored to the bone.

10. The device according to claim 8, characterized in that the respective fixing element (20) can be anchored to the tooth.

11. The device according to claim 1, characterized in that said profiled element (1) is composed of link elements that can be screwed to one another and are adjustable in their relative position to one another.

12. The device according to claim 2, characterized in that said profiled element (1) is arranged on said rear fixing element by means of an articulation (5).

13. The device according to claim 12, characterized in that said articulation (5) comprises a ball element that can be anchored in the bone and is gripped around by a clamp member which can be allocated to said profiled element (1).

14. The device according to claim 12, characterized in that said articulation is formed by a plug-type connection.

15. The device according to claim 2 and 12, characterized in that said rear fixing element assumes the shape of a screw (4) with a ball head (5).

16. The device according to claim 1, characterized in that said rear fixing element is provided with at least two brackets that extend on the exterior and interior side of the ramus ascendens and comprises holes for one or more bone screws at least at the one side.

17. The device according to claim 2, characterized in that said rear fixing element comprises a clip that can be activated by a screw and has ends gripping around the rear and front edge of the ramus ascendens.

18. The device according to claim 1 and 17, characterized in that said rear and front clips are each provided in the middle of the curvature with an inwardly bent mandrel which is configured to engage into and anchor itself in the bone upon tightening of said screw.

19. The device according to claim 1, characterized in that said front fixing element is connected by means of a strap to said profiled element (1).

20. The device according to claim 5, characterized in that for orosurgical measures each of said retaining members comprises an end in the form of a clip, which is U-shaped when viewed in cross-section, with free ends facing one another.

21. The device according to claim 20, characterized in that for orosurgical measures each of said retaining members has an end in the form of a pin.

22. The device according to claim 1, characterized in that for orosurgical purposes said fixing element extends to the lingual side in a bulging manner.

23. The device according to claim 1, characterized in that said profiled element (1) has a circular cross-section.

24. The device according to claim 1, characterized in that said profiled element has a non-circular cross-section for receiving a moment around its longitudinal axis.

25. The device according to claim 1, characterized in that said profiled element (1) has anchorage points forming a locking place (22).

26. The device according to claim 25, characterized in that said anchorage points are formed by grooves.

27. The device according to claim 25, characterized in that said anchorage points are formed by recesses (22).

28. The device according to claim 1, characterized in that said fixing element comprises a bar-shaped section (3) along which said profiled element (1) is held in a displaceable and lockable manner.
